(19) United States
(12) Patent Application Publication
(10) Pub. No.: US 2009/0101072 A1
(43) Pub. Date: Apr. 23, 2009

(54) INTERACTIVE DEVICES

(75) Inventor: Chih-Fei Lee, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: TAIKONG CORP., Taipei (TW)

(21) Appl. No.: 11/875,386

(22) Filed: Oct. 19, 2007

(51) Int. Cl. A01K 61/02; A01K 29/00; A01K 63/06

(52) U.S. Cl. 119/247; 119/6.5; 119/51.04

(57) ABSTRACT

The present invention relates to an interactive device comprising (a) a container with an object and water and (b) interactive equipment which causes interaction between (i) the object and a user or (ii) the object and other objects via the user's movements or driving by a sensor.

### FIELD OF THE INVENTION

The present invention relates to an interactive aquarium device. Especially, the present devices improve the interaction between a raiser and an aquarium living system.

### BACKGROUND OF THE INVENTION

When there has been supply of electric power in all houses since the First World War; the establishment of aquarium has also been prevalent. The development of new technology enabled ventilation device, filtration device, and water warming device even artificial illumination device to apply to a fish jar easily. Import of various special foreign species also made aquarium raising become people's hobby or recreation in daily life. There were approximately 60 million aquarium raisers around the world, like Europe, Asia and North America where aquarium raising prevailed over the area.

No matter which kind of fish jars, their essential structures were all nothing more than a filter system, a lighting system, an air pump and a warming device, or an additional steel bottle of carbon dioxide if cultivating water plants. The early development of the craft of fish jars had been intended for breeding, or research and development of garnitures. With the progress of technology, the concept of electronic-raising of pet was emerged. Raisers did not need to worry about feeding their fish because of the emergence of auto-feeder, and did not need to worry about the environmental change in the fish jar because the water quality monitoring system would send out alert message when the environment appeared unusually.

As the electronic commodity popularized, the relationship between people were progressively estranged, people even paid attention to pets but were alienated from the society. On the other hand, the situation of maltreatment of animals occurred increasingly, it is one of the reasons that the interaction between people and objects became poor.

Chinese Patent No. 03247849.6 relates to a kind of communication apparatus with a fish jar device. While using the telephone, users can reach happy and pleasing condition by watching the fish jar nearby.

### SUMMARY OF THE INVENTION

The present invention relates to an interactive device comprising (a) a container with an object and water and (b) interactive equipment which causes interaction between (i) the object and a user or (ii) the object and other objects via the user's movements or driving by a sensor.

### DETAILED DESCRIPTION OF THE INVENTION

The present invention relates to an interactive device comprising

(a) a container 10 with an object and water and

(b) interactive equipment 12 which causes interaction between (i) the object 11 and a user or (ii) the object and other objects via the user's movements or driving by a sensor.

In the device of the present invention, the container is made by transparent or semitransparent material.

The term “object” used herein includes but not limits to animals or insects (such as beetles, fireflies, brine shrimps, other insects etc.), water plants, land plants, collection, or mini-landscape which can make life fun.

In an embodiment, in order to be appropriate in order to raise many kinds of insects, the container can be shaped into a cylinder and the interactive device can be a replaceable pyramid cover to put new insects into the container easily and then increase the interaction between users and insects or insects and insects. In a preferred embodiment, a ring is attached to the pyramid cover to facilitate the convenience of hand-carry.

In an embodiment of observation box, the container can be shaped into a cylinder, and there is a hole on the top of the container; the interactive equipment can be a movable magnifier which can insert into the hole, and then users can observe the life cycle of insects easily without buying other equipment.

Adventure in the space brings mystery and excitation to every boy and girl in the world. In order to create and explore an adventure for child, the device of the present invention can be decorated with space scene, people (such as an astronaut) and an object (such as a UFO). In a preferred embodiment, the container is shaped into a UFO, wherein the inner and outer decoration is the extraterrestrial scene 40 with astronaut objects 50, and the interactive equipment is a feeder. In a further preferred embodiment, the container is shaped into an alien with a UFO-shaped cover, wherein the feeder delivers baits by rotating the UFO-shaped cover. In a further more embodiment, the device of the present invention includes light, illumination device and oxygen-supplied system (such as filter with bubble-produced system) to set up a mysterious atmosphere.

A pencil-sharpening-machine fish jar can represent a trustworthy, convenient and environmental-protecting technology. The pencil-sharpening-machine fish jar combines a small-scale fish jar and a pencil sharpening machine, and the fish feed is shaped into a pencil form. The feed can put into the pencil sharpening machine and then rotating the handle to sharpen and to lay the feed to the fish directly. When rotating the handle to feed the fish, the music recorder will be started, and then users can enjoy the fun of listening to the music while feeding the fish. Users can store energy to light the fish jar by pressing a power generator or switching a designed bottom and rotating the handle. Therefore, in a preferred embodiment, the interactive device is shaped into a form of pencil sharpening machine which include a rotating handle, a sharpening device 30, a music recorder, a power generating and storing device, a stick clipping device and a bottom to switch the function of the handle. The music recorder can be started while rotating the handle and the power generating and storing device can store power after switching or pressing the bottom and rotating the handle. In this embodiment, the interactive device further includes a pencil-shaped fish feed which can put into the pencil sharpening machine and then be sharpened and laid by rotating the handle.

In order to provide a fashionable appearance (such as an individual constellation pattern 20 on the surface), incoming telegram induction and light-emitting, after receiving telecommunication, in a preferred embodiment, the container is shaped into a cylinder, and the interactive device is also shaped into a cylinder and connected to the container. The appearance of the interactive device contains an individual constellation. In a further embodiment, the interactive equipment includes a music recorder, an illumination device, an incoming telegram inductor or a water purifier, water filter and bubble-produced system. The illumination device contains multicolored LEDs, and the incoming telegram inductor can emit light or sing while receiving telecommunication.

### BRIEF DESCRIPTION OF DRAWINGS

FIG. 1 shows one of the embodiments of the present invention, wherein the container is shaped into a cylinder, and the interactive equipment is also shaped into a cylinder and connected to the container. The appearance of the interactive device contains an individual constellation.

FIG. 2 shows one of the embodiments of the present invention, wherein interactive device is shaped into a pencil sharpening machine.

FIGS. 3 and 4 show one of the embodiments of the present invention, wherein the container is shaped into a UFO, and the inner and outer decoration is the extraterrestrial scene with astronaut objects.

FIG. 5 shows one of the embodiments of the present invention, wherein the container is shaped into a cylinder, and there is a hole on the top of the container; the interactive equipment is a movable magnifier which could be inserted into the hole.

FIG. 6 shows one of the embodiments of the present invention, wherein the container is shaped into a cylinder and the interactive equipment is a replaceable pyramid cover.

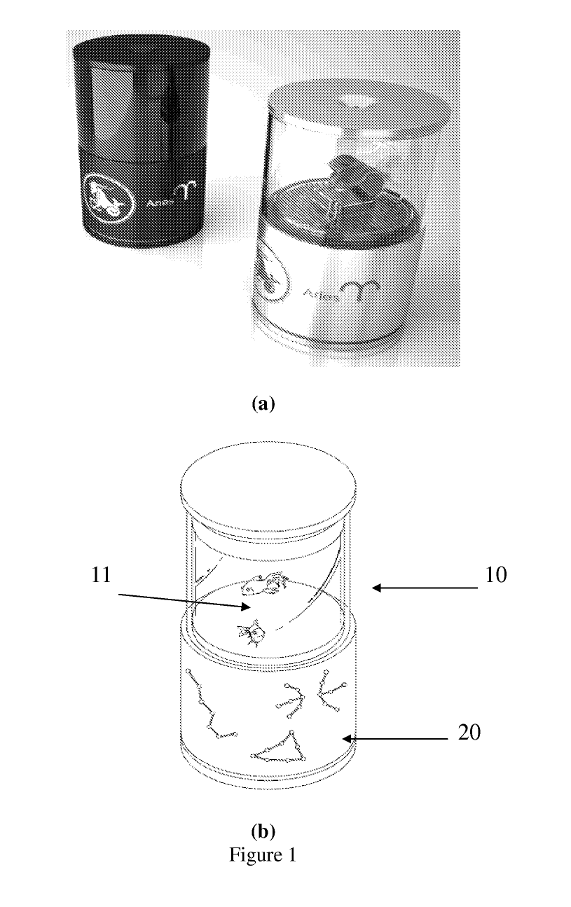

### EXAMPLES

### Example 1

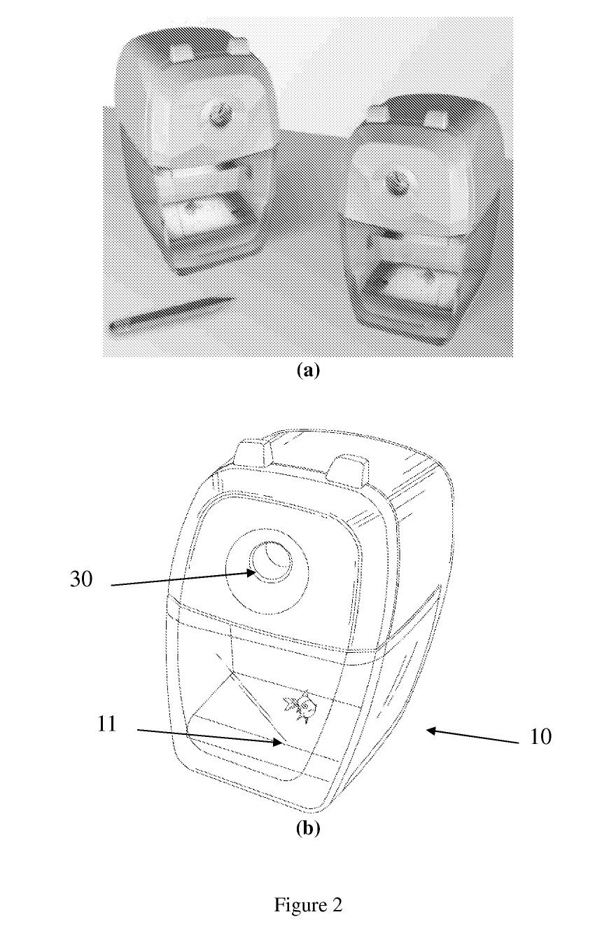

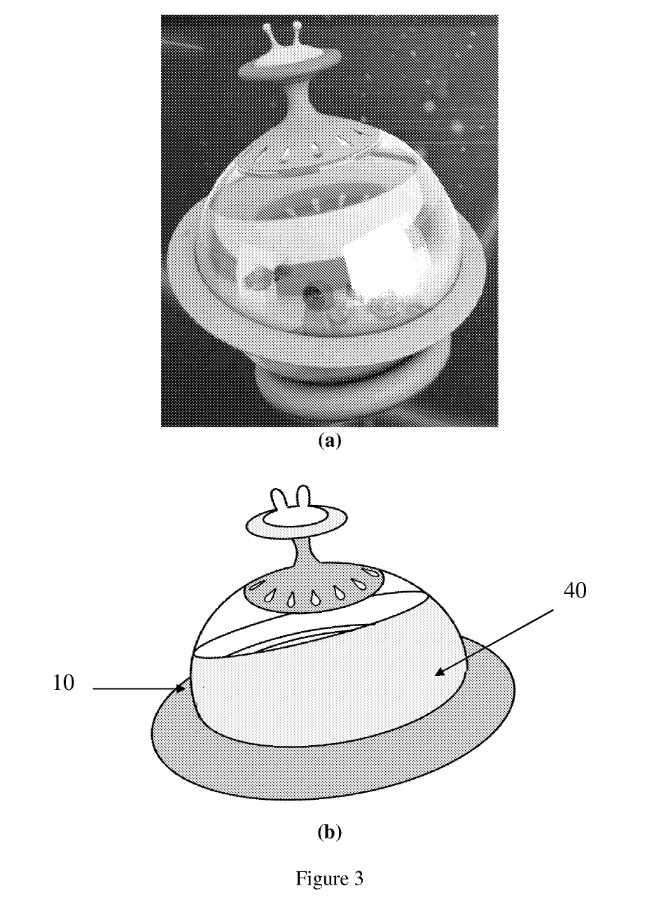

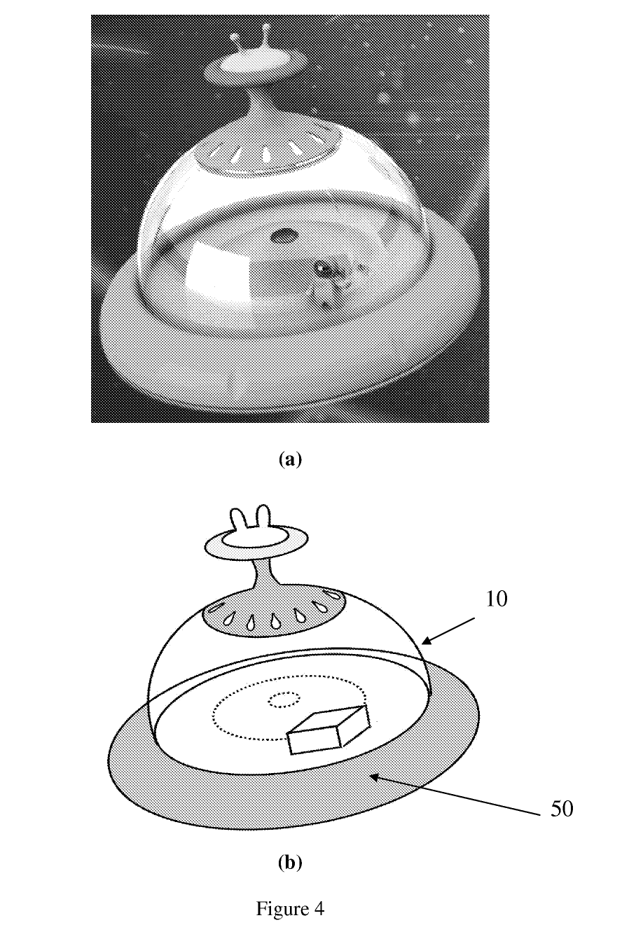

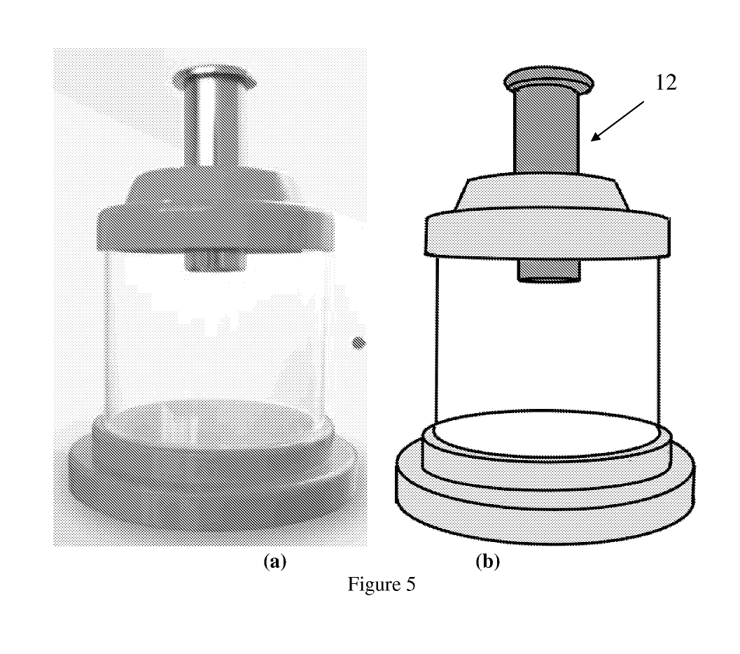

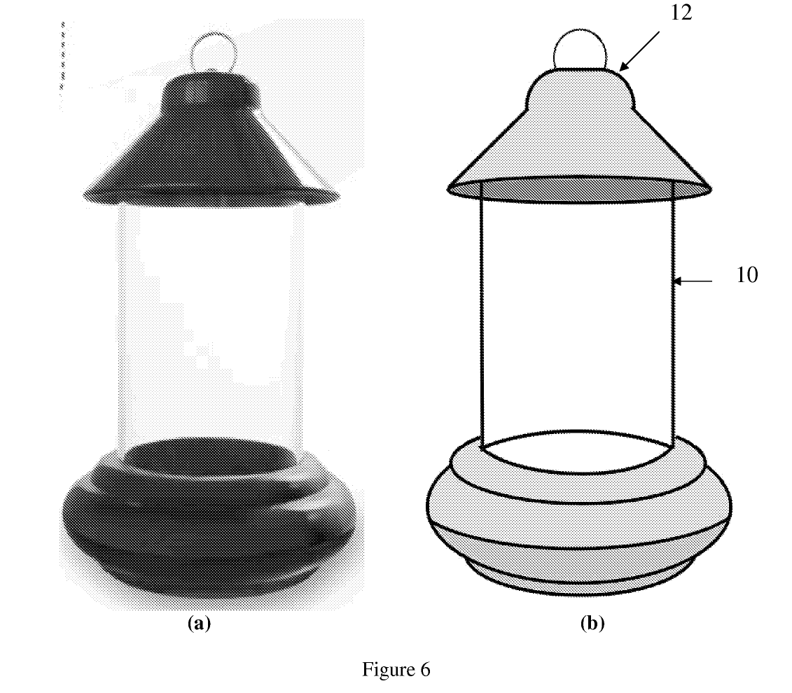

The pencil sharpening machine (FIG. 2) included a rotating handle, a sharpening device, a music recorder, a power generating and storing device, a stick clipping device 30 and a bottom to switch the function of the handle. Further, the fish feed was extruded into pencil shape and then was sealed by sealant to prevent spoiling.

Users could seal out the pencil-shaped fish feed and then put it into the pencil sharpening machine, rotated the handle to sharpen and to lay the feed to the fish. When rotating the handle and feeding the fish, the music recorder would be started; users could enjoy the fun of listening to the music while feeding the fish. Further, users could store energy to light the fish jar by pressing a power generator or switching a designed bottom and rotating the handle. At the normal condition, the music recorder would be started while the handle rotated, and the power generating and storing device could store energy after pressing or switch the bottom and rotating the handle.

### Example 2

The interactive device included a music recorder, illumination device with multicolored LEDs, an incoming telegram inductor or a water purifier (such as a filter and a bubble-produced system). When the mobile phone telegram came, the incoming telegram inductor could receive it and initiated LEDs to emit light on the fashionable appearance (such as an individual constellation pattern on the surface) to inform users of incoming calling; on the other hand, the inductor would start the music recorder and sing to further inform users of incoming calling.

What is claimed is:

1. An interactive device comprising:
(a) a container with an object and water and
(b) interactive equipment which causes interaction between (i) the object and a user or (ii) the object and other object via user's movements or driving by a sensor.

2. The device as claimed in claim 1, wherein the container is made by transparent or semitransparent material.

3. The device as claimed in claim 1, wherein the container is shaped into a cylinder.

4. The device as claimed in claim 1, wherein the objects are insects.

5. The device as claimed in claim 4, wherein the interactive equipment is a replaceable pyramid cover.

6. The device as claimed in claim 1, wherein the container is shaped into a cylinder, and there is a hole on the top of the container.

7. The device as claimed in claim 6, wherein the interactive equipment is a magnifier which inserted into the hole.

8. The device as claimed in claim 7, wherein the objects are insects.

9. The device as claimed in claim 8, wherein the container is shaped into a UFO.

10. The device as claimed in claim 9, wherein the inner and outer decoration is the extraterrestrial scene with astronaut objects.

11. The device as claimed in claim 9, wherein the interactive equipment is a feeder.

12. The device as claimed in claim 11, wherein the container is shaped into an alien with a UFO-shaped cover.

13. The device as claimed in claim 12, wherein the feeder delivers baits by rotating the UFO-shaped cover.

14. The device as claimed in claim 9, which includes light, illumination device and oxygen-supplied system.

15. The device as claimed in claim 14, wherein the oxygen-supplied system contains a filter with a bubble-produced system.

16. The device as claimed in claim 1, wherein the interactive equipment is shaped into a form of pencil sharpening machine.

17. The device as claimed in claim 16, wherein the pencil sharpening machine includes a rotating handle, a sharpening device, a music recorder, a power generating and storing device, a stick clipping device and a bottom to switch the function of the handle.

18. The device as claimed in claim 17, wherein the music recorder starts when rotating the handle.

19. The device as claimed in claim 17, wherein the bottom makes the power generating and storing device store power by switching or pressing it and rotating the handle.

20. The device as claimed in claim 17, which includes a pencil-shaped fish feed.

21. The device as claimed in claim 20, wherein the pencil-shaped fish feed can put into the sharpening device of the pencil sharpening machine and than be sharpened and laid by rotating the handle.

22. The device as claimed in claim 21, wherein the interactive equipment is shaped into a cylinder and connect to the container.

23. The device as claimed in claim 22, wherein the interactive equipment includes an individual constellation pattern on the surface.

24. The device as claimed in claim 22, wherein the interactive equipment includes a music recorder, an illumination device, an incoming telegram inductor or a water purifier, water filter and bubble-produced system.

25. The device as claimed in claim 24, wherein the incoming telegram inductor emits light or sing while receiving telecommunication.

26-30. (canceled)
